(19) United States
(12) Patent Application Publication
(10) Pub. No.: US 2009/0046664 A1
(43) Pub. Date: Feb. 19, 2009

(54) PACKET TRANSFER CONTROL DEVICE AND MOBILE NODE

(75) Inventor: Keigo Aso, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/293,171

(22) PCT Filed: Mar. 16, 2007
(86) PCT No.: PCT/JP2007/055455

§ 371 Date: Sep. 16, 2008

(30) Foreign Application Priority Data
Mar. 17, 2006 (JP) 2006-075556

(51) Int. Cl. H04W 36/00

(52) U.S. Cl. 370/331

(57) ABSTRACT

A technique is disclosed, by which it is possible to perform retransmission control of a packet effective for a mobile node in a home agent. According to this technique, after being intercepted, among the packets encapsulated and transmitted and addressed to MN 10, MN 10 selects a packet to be transferred to a specific care-of address at HA, a packet having a specific flow information, or a packet transmitted to a specific correspondent node (e.g. CN 40). Then, MN 10 requests HA to perform buffering on the selected packets when the selected packets are to be transferred. As a result, even when the connection of MN is turned to unstable and the packet cannot reach MN from HA, HA can transfer the packet currently in buffering. This makes it possible to reduce the delay of the packet to reach MN compared with a case where the packet is retransmitted from CN.

### TECHNICAL FIELD

The present invention relates to a communication control method for controlling communication by using Internet protocol (IP). In particular, the invention relates to a communication control method for buffering control and retransmission control of IP packet.

### BACKGROUND ART

In the past, various causes have been known, which may induce failure or trouble in the communication performed by using network. In particular, when a node (radio communication node) is connected to Internet via radio communication, problems including packet loss or time delay may arise from the reasons such as the changes in electric wave conditions.

To overcome the above problems, the Non-Patent Document 1 as given below describes a TCP (Transmission Control Protocol) layer of a source node (a transmission source node), and this TCP defines the retransmission of a packet when there is no acknowledgment (ACK) from a correspondent node to the transmitted data packet. Also, the TCP layer of the source node may perform the retransmission of the packet when a destination unreachable message of ICMP (Internet Control Message Protocol) is received, which is transmitted back in the situations where the transfer to the destination cannot be carried out any more from some reason.

However, the two methods as described above relate to retransmission control on end-to-end basis, and although the packet loss can be improved, retransmission delay (delay in the retransmission control) may occur when a source located at the remotest position from the receiving node of the packet executes the retransmission. As a method to improve the retransmission delay caused by the end-to-end retransmission control as given above, a method is proposed in the Non-Patent Document 2 as given below, by which the retransmission control is carried out by a router present on the transfer route.

According to the method proposed in the Non-Patent Document 2, a router on the network is provided with the function of the retransmission control, which has been performed by the transmission node in the past. This router detects whether it is necessary to retransmit the packet or not, and if it is detected that the retransmission of the packet is necessary, the packet under buffering is transferred (retransmitted). By using this method, when a problem arises that the retransmission is required, the source node performs the retransmission as disclosed in the Non-Patent Document 1, but the router at a position relatively closer to the point where the problem has occurred (a relay point of the packet) retransmits the packet. As a result, it is possible to reduce the retransmission delay compared with a case where the source node performs the retransmission of the packet.

However, the capacity to be buffered by a single router for the retransmission is limited. In case buffer capacity of the router to carry out the buffering is relatively lower compared with the amount of the packets to be buffered, the router cannot buffer all packets, which require the buffering. This results in the loss of packet. As a method to improve the problems in such case, a method can be proposed to transfer the overflowing packets to another router, which is able to buffer at the time when the buffer is completely filled with the packets. By using this method, the buffer capacity can be actually increased, and even when the buffer capacity of a single router is limited, the delay in transmitting or the packet loss according to the method proposed in the Non-Patent Document 2 can be improved and reduced.

Next, description will be given on a case where the retransmission control by the TCP is applied to the communication between a MN (Mobile Node) using the Mobile IPv6 and a CN (Correspondent Node) when MN performs communication with CN via HA (Home Agent) from the destination of its moving (the state where MN is connected to a foreign network), two communication routes can be conceived: a route between CN and HA where the packets are not encapsulated, and a route between HA and MN where the packets are encapsulated.

When CN knows only HoA (Home Address) of MN, transmission is performed by setting HoA of MN as the destination address of the packet to be transmitted to MN. The packet transmitted from CN is transferred to the home network of MN, and after it is intercepted by HA on the home network of MN, it is encapsulated and transferred to CoA of MN. The packet, which is flowing between CN and HA, is turned to a packet encapsulated by HA.

It is supposed here that the router between CN and HA judges that the packets transmitted by CN cannot be transferred any more due to some reason. In this case, the destination unreachable message is transmitted back to CN, which is the source, by ordinary processing of the router. As a result, the TCP layer of CN can carry out the retransmission control.

On the other hand, it is supposed here that the router between HA and MN judges that the packet transmitted by CN cannot be transferred from some reason. In this case, the destination unreachable message is transmitted to HA because the source address of the transfer packet is the address of HA. According to the Mobile IPv6, when a destination unreachable message with respect to the encapsulated packet transmitted to MN is received by HA, the packet must be relayed to CN, which is the original source of the packet. In so doing, an unreachable message of the packet is transmitted to CN, and the TCP layer of CN can perform the retransmission control to overcome the failure occurred between HA and MN. However, there is no change in the problem of the retransmission delay because the retransmission by TCP is carried out on end-to-end basis even in the communication using the Mobile IPv6.

Further, the retransmission control method by the router on the transfer route as described above (i.e. the retransmission control method as disclosed in the Non-Patent Document 2) can also be applied to the communication between MN and CN using the Mobile IPv6. In this case, when problem may arise on the route between CN and HA, the same effects as those described above would be provided. However, when MN moves, the care-of address (CoA) of MN is also changed. As a result, the packet to the care-of address before the moving of MN cannot reach MN as originally aimed even when it is retransmitted. Because the router with the retransmission control function cannot cope with the change of address associated with the moving of MN, there is not much effect to overcome the problem on the router between HA and MN. Specifically, when MN moves, which uses the care-of address, i.e. the destination of the packet, the destination unreachable message occurs if it is not present on the network any more. In such case, even when the retransmission control method as disclosed in the Non-Patent Document 2 is executed by the router between HA and MN, the retransmitted packet cannot reach MN.
[Non-Patent Document 1] J. Postel: “Transmission Control Protocol”; RFC793; September 1981.
[Non-Patent Document 2] Osamu SHIMOKUNI, Hisashi KOGA, and Akira JINZAKI: “A Reliable Multicast for Wide-Area Parallel and Distributed Systems”; A study report at the Information Processing Society of Japan; A report at the Computer Architecture Study Group; Vol. 2000, No. 23, pp. 53-58; Mar. 2, 2000.

In the communication between MN and CN using the Mobile IPv6, HA positioned on the route can be provided with the function to perform the retransmission control disclosed in the Non-Patent Document 2 as given above. In this case, HA controls the mobile behavior of MN, and when the transferred packet does not reach MN, the packet can be retransmitted by following the moving of MN. However, the retransmission control by HA is not necessarily preferable in all cases for MN. Specifically, when HA performs the same retransmission control to all packets, the buffering and the retransmission control are also carried out for the packets, which may be placed under the influence of packet loss or delay (i.e. the packet, to which the retransmission control is not particularly effective), in addition to the packet, for which it is not desirable to put under the influence of packet loss or delay (i.e. the packet, for which the retransmission control is effective). As a result, by the processing and the resource consumption to the packets, which may be put under influence of packet loss or delay, packet loss or delay may occur to the packet, for which it is not desirable to put under the influence of packet loss or delay.

HA has a binding cache of MN. However, when MN is temporarily disconnected, and when the binding update to update the lifetime from HA to MN is not received after a certain period of time, HA deletes the entry relating to MN from the binding cache. In this case, HA stops the intercept of the packet to the home address of MN. As a result, the packet addressed to the home address as transmitted by CN does not reach MN. ON the other hand, when the disconnection of MN is only temporary, HA receives the binding update from MN and re-registers the entry relating to MN in the binding cache, while the packet transmitted from CN during the temporary disconnection of MN does not reach MN and all packets are abandoned. As a result, it is necessary that CN retransmits the packets, and this leads to packet loss or delay.

Also, when MN can use a plurality of HAs and home address is assigned from each of the HAs, the address, which is always effective, can be continuously registered as the care-of address by associating a certain home address as a care-of address to another home address. If a certain MN performs this registration, when a packet is transferred from CN to MN, packet is encapsulated by using the home address registered as the care-of address. Thus, the encapsulated packet is transmitted from HA.

However, when MN loses effective care-of address due to the reason such as the disconnection, i.e. when the transfer destination address cannot be registered at a certain HA, by which the transfer packet cannot be transmitted to HA, the transfer destination address for the packet to reach HA itself may not be registered for another HA, too. For this reason, the packet, which has been encapsulated and transferred to HoA by a certain HA, is processed again as a packet, which has no transfer destination to MN by another HA as intercepted, and the transfer packet is intercepted by this HA. Therefore, a problem arises that mere registration of home address as the care-of address does not constitutes effective registration for MN.

### DISCLOSURE OF THE INVENTION

To overcome the above problems, it is an object of the present invention to provide a packet transfer control device and a mobile node, by which it is possible to perform the retransmission control with respect to a packet effective to MN, when a packet is transmitted to MN via HA from CN.

To attain the above object, the present invention provides a packet transfer control device for controlling packet transfer of a home agent belonging to a certain predetermined network, wherein said device comprises:

binding information controlling means for performing address control of a mobile node to which a home address is assigned from said predetermined network;

packet transferring means for intercepting a first packet addressed to said home address, for generating a second packet by encapsulating said first packet by using a header addressed to said care-of address, and for generating and transferring the second packet;

buffering request receiving means for receiving, from said mobile node, a request of buffering of transfer packet satisfying a predetermined condition in the transfer of the packet performed by said packet transfer means; and

buffering means for performing buffering of said transfer packet satisfying said predetermined condition when a request of buffering of said transfer packet satisfying said predetermined condition is received by said buffering request receiving means.

With the arrangement as described above, for a packet to be transmitted to MN (mobile node) via HA (home agent) from CN (correspondent node), MN can select a packet effective to itself and can arrange that the retransmission control of the selected packet can be carried out at the home agent.

Further, in addition to the above arrangement, the present invention provides the packet transfer control device as described above, wherein said predetermined condition is at least one of the following conditions: a condition that destination of the transfer packet is a predetermined care-of address, or a condition that the transfer packet has predetermined flow information, or a condition that said transfer packet is a packet transmitted from a predetermined correspondent node.

With the arrangement as described above, MN can adequately select a packet to be transferred to a predetermined care-of address, a packet having a predetermined flow information, or a packet transmitted from a predetermined correspondent node, and it can be so arranged that the retransmission control of the selected packet can be carried out at the home agent.

Also, in addition to the above arrangement, the present invention provides the packet transfer control device as described above, wherein said buffering request receiving means is so arranged to receive a request to perform buffering on said transfer packet at the same time as the transfer of said transfer packet from said mobile node.

With the arrangement as described above, the home agent can perform the buffering of the transfer packet at the same time as the transfer of the transfer packet, and when the transfer packet cannot reach the mobile node, the transfer packet under buffering can be retransmitted.

Further, in addition to the above arrangement, the present invention provides the packet transfer control device as described above, wherein said buffering request receiving means is so arranged to receive a request to temporarily perform buffering from said mobile node before said transfer packet is transferred from said mobile node.

With the arrangement as described above, the transfer of the packet to the mobile node can be intentionally delayed by performing the packet transfer by the home agent after the buffering of the transfer has been carried out temporarily before the transfer of the transfer packet, and even when the mobile node is temporarily in unreachable state, for instance, packet loss can be suppressed by so arranging that the buffering can be performed on the packet until the moment when the mobile node returns to the reachable state.

Also, in addition to the above arrangement, the present invention provides the packet transfer control device as described above, wherein said care-of address is a home address assigned to said mobile node from said predetermined network.

With the arrangement as described above, the buffering can be performed on the packet on the network side by the packet transfer between a plurality of home agents. As a result, the transfer of the packet to the mobile node can be intentionally delayed. Even when the mobile node is temporarily unreachable state, for instance, packet loss can be suppressed by so arranging that the buffering can be performed on the packet until the time when the mobile node returns to the reachable state.

Further, the present invention provides a mobile node having, in addition to a first address as assigned from a first network, a second address assigned from a second network different from said first network, wherein said mobile node comprises:

address associating means for setting said first address as a home address and for associating said second address as a care-of address of said first address;

binding information registration means for registering binding information of said first address and said second address associated by said address associating means at a home agent of said first network; and

buffering requesting means for intercepting the first packet addressed to said first address and for requesting buffering of transfer packet satisfying a predetermined condition to said home agent of said first network to transfer the second packet generated by encapsulating said first packet by using a header addressed to said second address.

With the arrangement as described above, with regard to the packet transmitted to MN from CN via HA, MN can select a packet effective for itself, and it can be arranged that the retransmission control of the selected packet can be performed at the home agent.

Also, in addition to the above arrangement, the present invention provides the mobile node as described above, wherein said predetermined condition is at least one of the following conditions: a condition that destination of the transfer packet is a predetermined care-of address, or a condition that the transfer packet has predetermined flow information, or a condition that said transfer packet is a packet transmitted from a predetermined correspondent node.

With the arrangement as described above, MN can adequately select a packet to be transferred to a predetermined care-of address, a packet having a predetermined flow information, or a packet transmitted from a predetermined correspondent node, and it can be so arranged that the retransmission control of the selected packet can be carried out at the home agent.

Further, in addition to the above arrangement, the present invention provides the mobile node as described above, wherein said buffering requesting means is so arranged to request buffering of said transfer packet to said home agent at the same time as the transfer of said transfer packet.

With the arrangement as described above, the home agent can perform the buffering of the transfer packet at the same time as the transfer of the transfer packet, and when the transfer packet cannot reach the mobile node, the transfer packet under buffering can be retransmitted.

Also, in addition to the above arrangement, the present invention provides the mobile node as described above, wherein said buffering requesting means is so arranged to request for temporary buffering before the transfer of said transfer packet to said home agent.

With the arrangement as described above, the transfer of the packet to the mobile node can be intentionally delayed by performing the packet transfer by the home agent after the buffering of the transfer has been carried out temporarily before the transfer of the transfer packet, and even when the mobile node is temporarily in unreachable state, for instance, packet loss can be suppressed by so arranging that the buffering can be performed on the packet until the moment when the mobile node returns to the reachable state.

Further, in addition to the above arrangement, the present invention provides the mobile node as described above, wherein said second address is a home address as assigned from said second network.

With the arrangement as described above, the buffering can be performed on the packet on the network side by the packet transfer between a plurality of home agents. As a result, the transfer of the packet to the mobile node can be intentionally delayed. Even when the mobile node is temporarily in unreachable state, for instance, packet loss can be suppressed by so arranging that the buffering can be performed on the packet until the moment when the mobile node returns to the reachable state.

The present invention has the arrangement as described above and can provide the effects that the retransmission control can be performed on the packet effective to MN when the packets are transmitted from CN to MN via HA.

### BRIEF DESCRIPTION OF THE DRAWINGS

FIG. 1 is a drawing to show an example of network arrangement in a first embodiment of the present invention;

FIG. 2 is a drawing to show an example of arrangement of MN 10 in the first embodiment of the present invention;

FIG. 3 is a drawing to show an example of a binding information notifying message generated and transmitted by MN 10 in the first embodiment of the invention;

FIG. 4 is a drawing to show an example of a flow information notifying message generated and transmitted by MN 10 in the first embodiment of the invention;

FIG. 5 is a drawing to show an example of a buffering request message generated and transmitted by MN 10 in the first embodiment of the invention;

FIG. 6 is a drawing to show an example of arrangement of HA 60 in the first embodiment of the invention;

FIG. 7 is a drawing to show an example of network arrangement in a second embodiment of the invention;

FIG. 8 is a drawing to show an example of arrangement of MN in the second embodiment of the invention;

FIG. 9 is a drawing to show a binding information notifying message generated and transmitted by MN in the second embodiment of the invention;

FIG. 10 is a drawing to show an example of arrangement of HA in the second embodiment of the invention;

FIG. 11 is a drawing to show an example of arrangement of MN in a third embodiment of the invention;

FIG. 12 is a drawing to shown an example of arrangement of HA in the third embodiment of the invention; and

FIG. 13 is a drawing to show an example of network arrangement having a proxy mobile node in the first to the third embodiments of the invention.

### BEST MODE FOR CARRYING OUT THE INVENTION

Description will be given on the first to the third embodiments of the invention referring to the attached drawings.

### 1st Embodiment

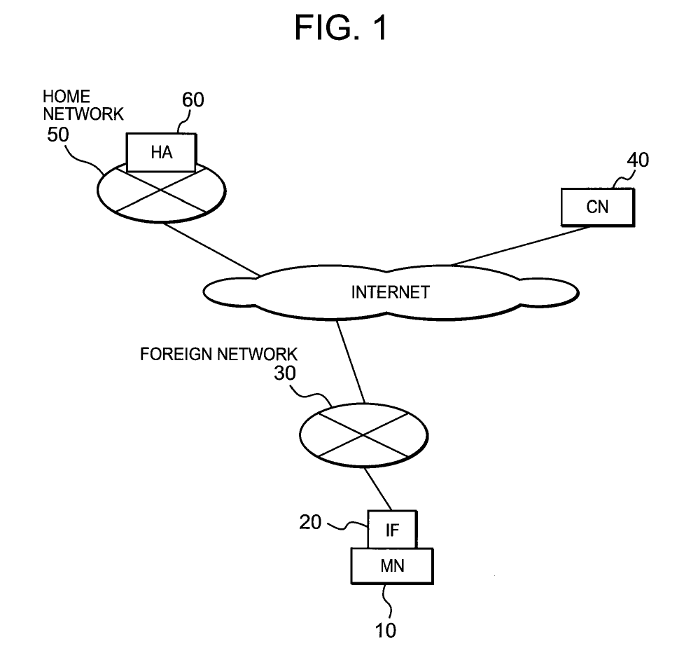

First, description will be given on the first embodiment of the invention. FIG. 1 shows an example of network arrangement in the first embodiment of the invention. In FIG. 1, MN 10 can utilize HA 60 in a home network 50 as its own home agent. A home address (HoA1) is assigned to MN 10 from the home network 50, and this HoA1 is controlled by HA 60. In FIG. 1, MN 10 is connected to a foreign network 30 via an interface (IF) 20, and CoA1 is assigned from the foreign network 30. On the other hand, it is supposed that the communication to and from CN 40 is performed via HA 60 by using HoA1.

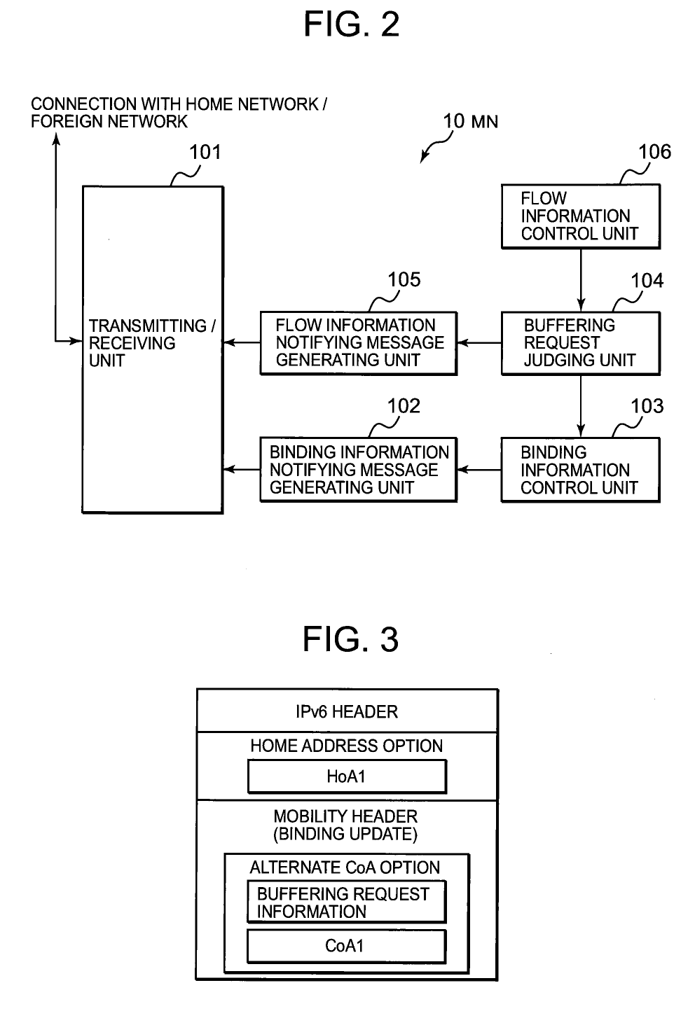

Next, description will be given on an arrangement of MN 10 in the first embodiment of the invention. FIG. 2 shows an example of arrangement of MN 10 in the first embodiment of the invention. In FIG. 2, MN 10 has a transmitting/receiving unit 101, a binding information notifying message generating unit 102, a binding information control unit 103, a buffering request judging unit 104, a flow information notifying message generating unit 105, and a flow information control unit 106. MN 10 has a data packet processing unit for processing data packet transmitted and received between MN 10 and CN 40 and various other functions, but these are not shown in the figure.

The transmitting/receiving unit 101 has packet transmitting/receiving function to perform communication with an arbitrary communication node in a network, to which MN 10 is connected (e.g. in the foreign network 30 shown in FIG. 1), an arbitrary node in the home network of MN 10 (e.g. HA 60 shown in FIG. 1), and an arbitrary communication node existing in other arbitrary network (e.g. HA 60 shown in FIG. 1). The transmitting/receiving unit 101 also has a function of a radio-connection interface 20 as shown in FIG. 1.

Also, the binding information notifying message generating unit 102 has the function to generate binding information notifying message including binding information notified from the binding information control unit 103. The binding information notifying message generated at the binding information notifying message generating unit 102 is a message to request to HA 60 to perform buffering of a packet addressed to the care-of address as specified by the binding information, and this is transmitted to HA 60 via the transmitting/receiving unit 101.

The binding information control unit 103 has the function to control care-of address associated with HoA1 as controlled by HA 60. At the binding information control unit 103, a set of HoA1 controlled by HA 60 and the care-of address associated with HoA1 is controlled as binding information.

Also, the binding information control unit 103 has the function to give an instruction to the binding information notifying message generating unit 102 to generate a binding information notifying message by delivering binding information to be notified or information added with the binding information (e.g. a buffering request information as given below) when it is necessary to notify the binding information to HA 60. Further, the binding information control unit 103 has the function to control by adding buffering request information to its care-of address when an instruction is given from the buffering request judging unit 104 to add buffering request to a specific care-of address.

Also, the buffering request judging unit 104 has the function to judge whether buffering should be requested or not to a specific care-of address or to a specific flow. When it is decided that buffering is to be requested to a specific care-of address, the buffering request judging unit 104 has the function to give an instruction to the binding information control unit 103 to add buffering request to the care-of address in question. Also, when it is decided that the buffering should be requested to a specific flow (a data traffic flow), the buffering request judging unit 104 has the function to give an instruction to the flow information notifying message generating unit 105 to supply an identifier to specify the flow in question and to generate flow information notifying message to give buffering request to the flow.

For instance, under the conditions that radio connection of the interface 20 is not stable and that the connection is lost intermittently, the buffering request judging unit 104 can decide that buffering request should be added to the care-of address assigned to the interface 20. This makes it possible for HA 60 to selectively perform buffering of the packet to be transferred to a specific care-of address, and to minimize the packet loss caused by intermittent break of radio connection.

Also, the buffering request judging unit 104 can decide that a buffering request should be added to a flow, which is sensitive to packet loss. The flow sensitive to packet loss can be identified by notification from a flow information control unit 106, for instance. As a result, a flow sensitive to packet loss can be discriminated from a flow, which is more sensitive to transmission delay or jitter than to packet loss, and it can be arranged that HA 60 selectively performs buffering to a packet relating to the flow sensitive to packet loss.

The flow information notifying message generating unit 105 has the function to generate a flow information notifying message including a specific flow identifier when an instruction to perform buffering request to the specific flow is received together with a specific flow identifier from the buffering request judging unit 104. The flow information notifying message generated at the flow information notifying message generating unit 105 is a message to request HA 60 to perform buffering of a packet relating to a flow specified by the flow identifier, and the message is transmitted to HA 60 of MN 10 via the transmitting/receiving unit 101.

The flow information control unit 106 has the function to control packet flow, and it can control the flow information (flow identifier) and can control the characteristics of each flow (e.g. whether it is sensitive to the packet loss or not). Also, the flow information control unit 106 can notify flow information relating to a flow sensitive to the packet loss to the buffering request judging unit 104.

In FIG. 2, it is so arranged that MN 10 can transmit both a binding information notifying message and a flow information notifying message to HA 60, while it may be so designed that either one of the notifying messages can be transmitted. That is, MN 10 may simply notify the care-of address of an object, to which buffering request is to be added by the binding information notifying message, or may simply notify the flow of an object, for which buffering request is to be added by the flow information notifying message, or both the care-of address and the flow of an object, to which buffering request is to be added, may be notified by using both of these messages.

In the arrangement of MN 10 shown in FIG. 2, if the object, to which buffering request is to be added, is a care-of address, the binding notifying message is used, and if the object to be added with the buffering request is a flow, the flow information notifying message is used, but the binding information notifying message may be used as a message to notify the buffering request to the flow, for instance. In this case, the buffering request information to the flow can be added as an option to the binding information notifying message. Also, the flow information notifying message may be used as a message to notify the buffering request to the care-of address.

As described above by referring to FIG. 2, MN 10 in the first embodiment of the present invention can request to its own HA 60 to selectively perform buffering to the packet addressed to a specific care-of address, or to a packet relating to a specific flow. Or, it may be so arranged that, in addition to the packet addressed to a specific care-of address or the packet relating to a specific flow, it may request to selectively perform buffering to a packet, which has been transmitted from a specific correspondent node. In this case, MN 10 can simply notify the address of the correspondent node, for instance, to HA 60 as the object of the buffering request.

FIG. 3 shows an example of a binding information notifying message generated and transmitted by MN 10 in the first embodiment of the invention. FIG. 3 shows an example of arrangement of the binding information notifying message when buffering is requested to a specific care-of address (CoA1 associated with HoA1) by using a binding update message.

An IPv6 header (to set HA 60 as a destination address) shown in FIG. 3, a home address option, and a mobility header (binding update) as shown in FIG. 3 are basically the same as those in the arrangement of the binding update message defined in the Mobile IPv6. In the first embodiment of the invention, as shown in FIG. 3, the buffering request information and the care-of address specified as the object of buffering are added to an alternate CoA option of the binding update message defined in the Mobile IPv6. The buffering request information is the information to indicate buffering request of a packet, which has the care-of address (CoA1 in the example shown in FIG. 3) included in the alternate CoA option. For instance, it can be realized in an arbitrary form such as a flag.

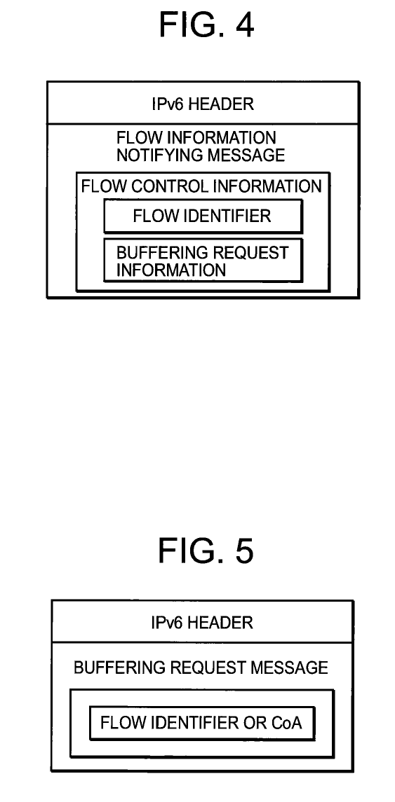

FIG. 4 shows an example of a flow information notifying message generated and transmitted by MN 10 in the first embodiment of the invention. FIG. 4 shows an arrangement example of the flow information notifying message when buffering is requested to a specific flow identifier by using the flow control message.

As shown in FIG. 4, the flow information notifying message is realized by inserting the flow control information, which has a flow identifier to specify the flow to be an object of the buffering request and the buffering request information expressed in an arbitrary form (information to indicate buffering request of the packet relating to the flow identifier as given above), into the flow control message, which has the IPv6 header (with HA 60 set to a destination address). The flow information notifying message may be realized by inserting the flow identifier as given above and the buffering request information to the mobility header as defined in the Mobile IPv6.

FIG. 5 shows an example of a buffering request message generated and transmitted by MN 10 in the first embodiment of the invention. Instead of the binding information notifying message (e.g. an arrangement as shown in FIG. 3) or the flow information notifying message (e.g. an arrangement shown in FIG. 4), a special-purpose buffering request message including a care-of address or a flow to be an object of the buffering request may be used as shown in FIG. 5 as a message to notify the buffering request to a specific care-of address or a specific flow as shown in FIG. 5. The buffering request message as shown in FIG. 5 may be in itself the buffering request information to indicate buffering request of the packet.

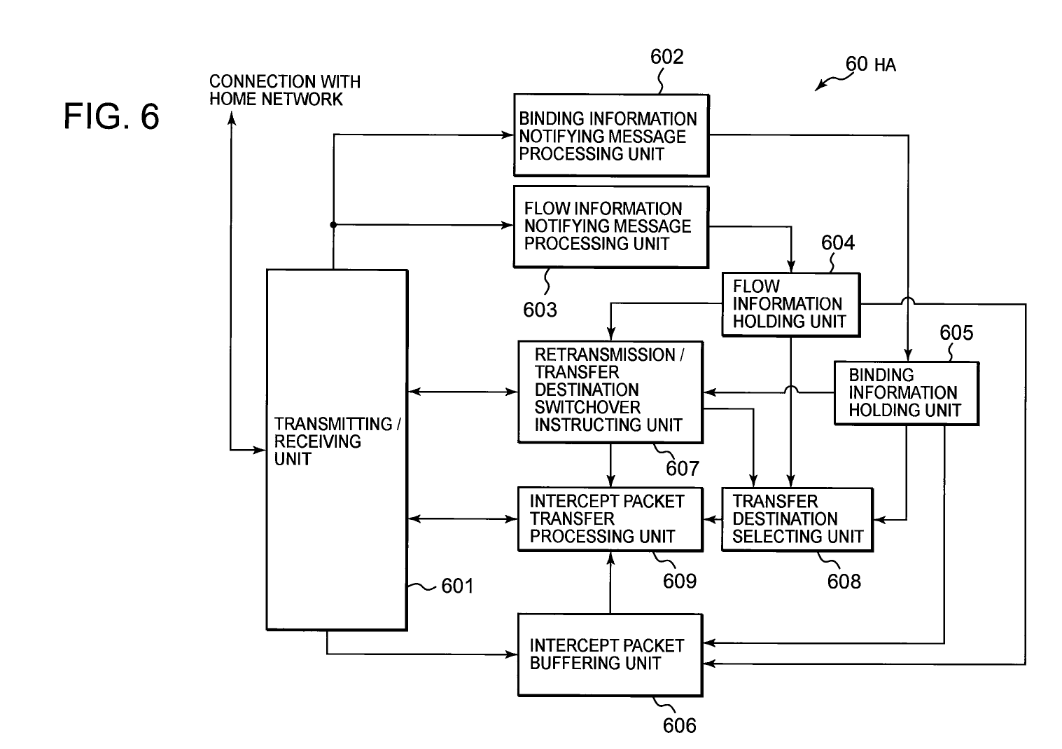

Next, description will be given below on an arrangement of HA 60 in the first embodiment of the invention. FIG. 6 shows an example of arrangement of HA 60 in the first embodiment of the invention. In FIG. 6, HA 60 comprises a transmitting/receiving unit 601, a binding information notifying message processing unit 602, a flow information notifying message generating unit 603, a flow information holding unit 604, a binding information holding unit 605, an intercept (proxy receiving) packet buffering unit 606, a retransmission/transfer destination switchover instructing unit 607, a transfer destination selecting unit 608, and an intercept packet transfer processing unit 609. HA 60 has various other functions, but these are not shown in the figure.

The transmitting/receiving unit 601 has the function to transmit and to receive the packets to perform communication to and from an arbitrary communication node in a network, to which HA 60 is connected (e.g. a home network 50 in FIG. 1, to and from MN 10 connected to the foreign network 30 (i.e. MN 10 belonging to the home network 50 where HA 60 is present), or to and from an arbitrary communication node connected to other arbitrary network.

The binding information notifying message processing unit 602 has the function to perform processing relating to the binding information notifying message, to acquire binding information of MN 10 included in the binding information notifying message, and to make the binding information holding unit 605 to hold this binding information when the binding information notifying message generated and transmitted at MN 10 is received. When buffering request information is added with respect to the binding information, the buffering request information is held at the binding information holding unit 605 together with the binding information.

When a flow information notifying message generated and transmitted by MN 10 is received at the transmitting/receiving unit 601, the information notifying message processing unit 603 has the function to perform processing relating to the flow information notifying message, and it also has the function to acquire a flow identifier of MN 10 contained in the flow information notifying message and to hold this flow identifier at the flow information holding unit 604. If buffering request information is added for the flow identifier, an instruction is given to the flow information holding unit 604 to hold the buffering request information together with the flow identifier.

The flow information holding unit 604 has the function to hold a flow identifier (i.e. the flow identifier to be an object of buffering request of packet) extracted by the processing of the flow information notifying message at the flow information notifying message processing unit 603. At the flow information holding unit 604, flow information where the buffering request information is added and flow information where the buffering request information is not added are held.

The binding information holding unit 605 has the function to hold binding information extracted by the processing of the binding information notifying message at the binding information notifying message processing unit 602 (i.e. the binding information where home address of MN 10 and care-of address to be an object of buffering request of packet are associated). At the binding information holding unit 605, ordinary binding information where buffering request is not included is also held in addition to the binding information where buffering request of packet to be transferred to a specific care-of address is included.

The intercept (proxy receiving) packet buffering unit 606 has the function to check the flow identifier held at the flow information holding unit 604, and, if the buffering request information is added to the flow information, to perform buffering of the packet relating to a flow, which corresponds to the flow identifier. The intercept packet buffering unit 606 checks the binding information held at the binding information holding unit 605, and if the buffering request is added to the binding information, the intercept packet buffering unit 606 has the function to perform buffering of a packet, which corresponds to the binding information (i.e. the packet to be transferred to the care-of address included in the binding information). Specifically, at the intercept packet buffering unit 606, the packet buffering is performed only to the packet, which is an object of the buffering, as receiving the buffering request from MN 10.

The retransmission/transfer destination switchover instructing unit 607 has the function to judge whether the packet should be retransmitted or the transfer destination address in use should be switched over to another address when it is detected that the packet transferred to MN 10 has not reached MN 10 (e.g. when a destination unreachable message relating to the packet transferred to MN 10 has been received) or when congestion on the transfer route has been detected. When it is judged that the retransmission is required, the retransmission/transfer destination switchover instructing unit 607 gives an instruction to the intercept packet transfer processing unit 609 that the packet should be retransmitted.

On the other hand, the retransmission/transfer destination switchover instructing unit 607 gives an instruction to the transfer destination selecting unit 608 that another transfer destination address should be selected when it is judged that it is necessary to switchover the transfer destination address from the address as currently set to another address. In this case, the retransmission/transfer destination switchover instructing unit 607 gives an instruction to the transfer destination selecting unit 608 that the transfer destination address should be switched over to another address with regard to the packet, for which the transmission to the address before the switchover has failed. Also, the retransmission/transfer destination switchover instructing unit 607 gives an instruction to the intercept packet transfer processing unit 609 that the packet should be retransmitted to the transfer destination address as newly selected.

The transfer destination selecting unit 608 has the function to select the care-of address to be used as a transfer destination address from among the types of the binding information held at the binding information holding unit 605 as a transfer destination of the packet addressed to HoA of MN 10, which intercepted the packet. Also, the transfer destination selecting unit 608 has the function to select the care-of address to be used as the transfer destination of a specific flow as the transfer destination of the packet addressed to HoA of MN 10, which intercepted the packet, by referring to a flow identifier of MN 10 as held at the information holding unit 604, and also by referring to the binding information holding unit 605.

The intercept packet transfer processing unit 609 has the function to intercept the packet addressed to HoA of MN 10 under control and to encapsulate and transfer the packet to the care-of address selected by the transfer destination selecting unit 608. Also, the intercept packet transfer processing unit 609 has the function to retransmit the packet by acquiring the packet to be retransmit from the intercept packet buffering unit 606 when an instruction for retransmitting has been received from the retransmission/transfer destination switchover instructing unit 607. When a new transfer destination address is notified from the transfer destination selecting unit 608, the intercept packet transfer processing unit 608 has the function to encapsulate and transfer the packet to the notified transfer destination address.

As described in the above by referring to FIG. 6. HA 60 in the first embodiment of the invention can selectively perform the buffering only on the packet, for which it is requested to perform buffering from MN 10 (i.e. a packet to be transferred to a specific care-of address or a packet relating to a specific flow), and HA 60 can immediately retransmit the buffered packets when it is necessary to retransmit these packets.

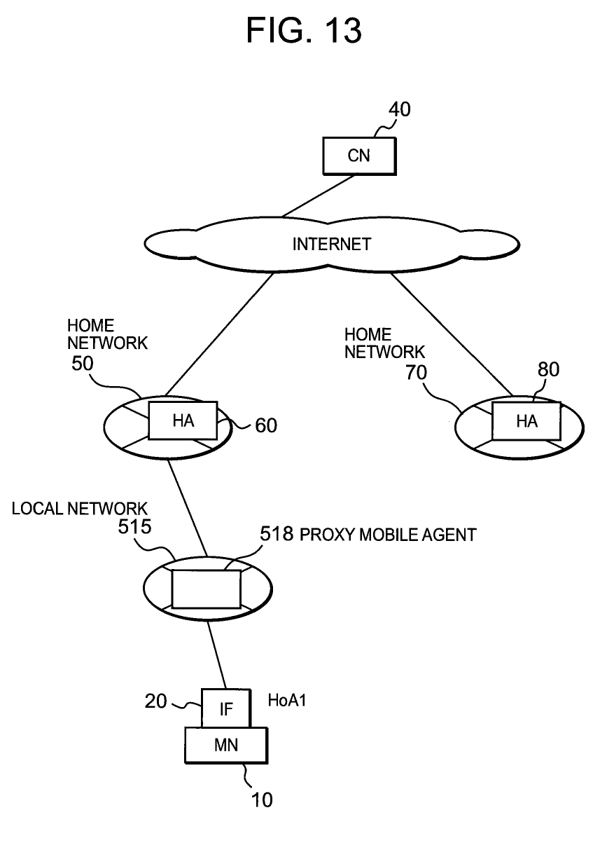

As shown in FIG. 13, when MN 10 is connected to a local network 515 where mobility protocol on network base is provided, a proxy mobile agent 518 to control the moving of MN 10 on proxy may have the function, which MN 10 of the first embodiment of the invention has. In this case, the proxy mobile agent 518 may selectively judge the object of the packet to be buffered at its own judgment or it may follow the instruction from MN 10. When the connecting condition of MN 10 is monitored at proper timing and it is found that the connection of MN 10 is stable, the proxy mobile agent 518 may select that the buffering request information may not be notified, and if the connection of MN 10 is lost or unstable, it may select the notifying of the buffering request information. The proxy mobile agent 518 notifies the buffering request information thus decided to HA 60, which has MN 10 under the control.

Also, the proxy mobile agent 518 may have the function to hold HA 60 in the first embodiment of the invention. In this case, MN 10 adds the buffering request information to the flow information and notifies it to the proxy mobile agent 518. If the packet addressed to the home address (HoA1) of MN 10 as transferred from HA 60 concurs with the flow where the buffering request information has been added, upon receipt of this information, the proxy mobile agent 518 performs buffering, and when it is judged that it is necessary to retransmit because the connection of MN 10 is unstable or from other reason, it is retransmitted by using the packet under buffering. It may be so arranged that the proxy mobile agent 518 monitors the connecting condition of MN 10 at adequate timing, and if the connection of MN 10 is stable, it may decide not to perform the buffering, and that buffering is performed when the connection is lost or unstable.

Next, description will be given on an example of actual operation of the first embodiment of the invention by referring to the network arrangement as shown in FIG. 1. In the following, assumption is made on a case where MN 10 is disconnected to the foreign network 30 from some reason. The causes of disconnection may include mobile behavior of MN 10, for instance.

### [A First Operation Example of the First Embodiment of the Invention]

First, description will be given below on a first operation example in the first embodiment of the invention. When it is connected to the foreign network 30, MN 10 registers the binding information of home address (HoA1) with care-of address (CoA1) at HA 60 as the processing in the Mobile IPv6. In this case, when it is decided that HA 60 is requested to perform buffering on a packet addressed to the care-of address registered in order to prepare for the intermittent disconnection from the foreign network caused by instability of radio connection or to prepare for packet loss on the packet transfer route, a binding information notifying message where the buffering request is added to its care-of address (CoA1) is transmitted to HA 60.

Upon receipt of the binding information notifying message, HA 60 stores the information included in the binding information notifying message at the binding information holding unit 605. HA 60 intercepts the packet addressed to HoA1 of MN 10 and transfers the packet to CoA1. At the same time, HA 60 buffers the packet to be transferred to CoA1 to the intercept packet buffering unit 606.

Here, assumption is made that MN 10 is disconnected to the foreign network 30 and the failure of HA 60 to transfer the packet to CoA1 of MN 10 has been detected by receiving a destination unreachable message. In this case, to cope with the failure of packet transfer to CoA1, HA 60 retransmits the packet by using the packet addressed to CoA as buffered to the intercept packet buffering unit 606. When MN 10 has registered a plurality of care-of addresses at HA 10, HA 60 does not perform buffering to the care-of address where there is buffering request from MN 10. Therefore, the packet relating to the care-of address with no buffering request is not retransmitted from HA 60.

When the disconnection between MN 10 and the foreign network 30 is only temporary and MN 10 could be re-connected to the foreign network 30, it is possible to prevent the packet loss for the packet addressed to CoA1 by means of the retransmission control by HA 60. In this retransmission control, the packet retransmission is carried out by HA 60. Thus, compared with the case where the packet is retransmitted by the source of the packet (e.g. CN 40), MN 10 would be able to receive the retransmitted packet at an earlier time.

Also, when MN 10 acquires a new care-of address (CoA2) by connecting to another network after a certain period of time, the packet to CoA1 under buffering may be transferred to CoA2. HA 60 may transfer the packet to CoA1 under buffering to CoA2 at the moment when CoA2 has been registered at HA 60 as a new transfer destination, and in so doing, the packet loss can be prevented.

### [A Second Operation Example of the First Embodiment of the Invention]

Next, description will be given on a second operation example in the first embodiment of the invention. When it is connected to the foreign network 30, MN 10 registers binding information of home address (HoA1) and care-of address (CoA1) as a normal processing of the Mobile IPv6. In this case, when MN 10 decides that a request is made on HA 60 to perform buffering of the packet relating to a specific flow (a flow 1) during communication in the preparation for intermittent disconnection with the foreign network, which has been caused by instability of radio connection or packet loss on the packet transfer route, MN 10 transmits a flow information notifying message added with buffering request to the flow 1.

Upon receipt of this flow information notifying message, HA 60 stores the information included in the flow information notifying message at the flow information holding unit 604. Also, HA 60 intercepts the packet addressed to HoA1 of MN 10 and transfers the packet to CoA1 and buffers the packet relating to the flow 1 to the intercept packet buffering unit 606.

It is supposed here that MN 10 has been disconnected to the foreign network 30, and by the receiving of the destination unreachable message, it is detected that HA 60 has failed the transfer of the packet to CoA1 of MN 10. To cope with the failure of the packet transfer to CoA1, HA 60 retransmits the packet by using a packet relating to the flow 1 under buffering at the intercept packet buffering unit 606. In this case, HA 60 does not perform buffering to the flow where there is no buffering request from MN 10. Therefore, the packet relating to the flow where there is no buffering request is not retransmitted from HA 60.

When the disconnection of MN 10 with the foreign network 30 is only temporary and MN 10 can be re-connected to the foreign network 30, the packet loss of the packet relating to the flow 1 can be prevented by the retransmission control by HA 60. In this retransmission control, packet retransmission is carried out by HA 60. Thus, compared with the case where packet retransmission is performed by the source of the packet (e.g. CN 40), MN 10 would be able to receive the retransmitted packet at an earlier time.

When MN 10 is connected to another network after a certain period of time and has acquired a new care-of address (CoA2), the packet relating to the flow 1 under buffering can be transferred to CoA2 at the moment when CoA2 has been registered at HA 60 as a new transfer destination. In so doing, the packet loss can be prevented.

As described above, according to the first embodiment of the invention, MN can request HA to perform buffering only on a packet transmitted to a specific care-of address of its own or only on a packet preferable to MN (e.g. a packet sensitive to packet loss) by requesting the buffering of the packet relating to a specific flow, and it is possible to perform the retransmission of the packet from HA as necessary. This contributes to the accomplishment of efficient retransmission control.

### 2nd Embodiment

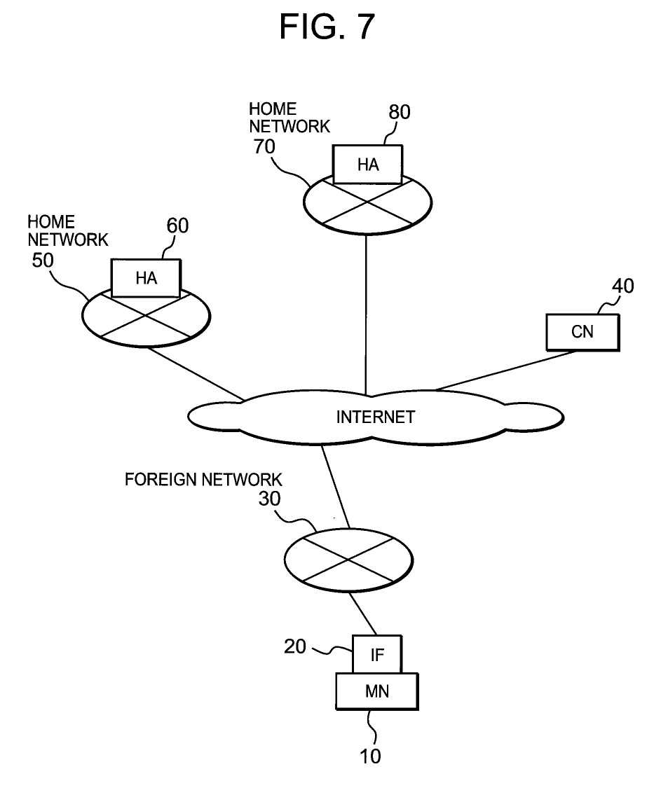

Next, description will be given below on a second embodiment of the invention. FIG. 7 shows an example of network in the prevent invention. In FIG. 7, MN 10 can utilize HAs (HA 60 and HA 80), which are present in a plurality of home networks (home networks 50 and 70) respectively. Home addresses (HoA1 and HoA2) of the home networks 50 and 70 are assigned to MN 10 respectively, and these home addresses HoA1 and HoA2 are controlled by HAs (HA 60 and HA 80) respectively. It is supposed in FIG. 7 that MN 10 is connected to the foreign network 30 via an interface (IF) 20 and CoA1 is assigned from the foreign network 30, and that communication via HA 60 is performed by using HoA1 for the communication with CN 40.

The number of interfaces used by MN 10 is not limited to one, and two or more interfaces may be used. In this case, two or more care-of addresses may be associated with each of HoA1 and HoA2 respectively. Also, the number of HAs (HA 60 and HA 80) usable by MN 10 is not limited to two as shown in FIG. 7, and more HAs may be used. In this case, it is required that home addresses are assigned from each of the plurality of HAs.

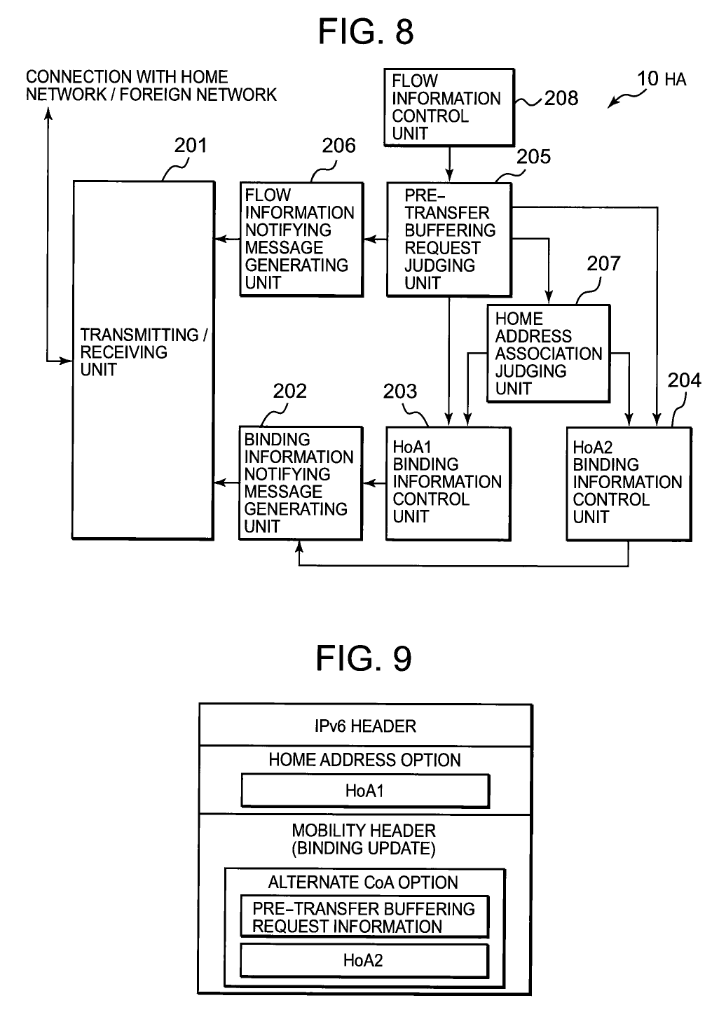

Next, description will be given on an arrangement of MN 10 in the second embodiment of the invention. FIG. 8 shows an example of arrangement of MN 10 in the second embodiment of the invention. In FIG. 8, MN 10 comprises a transmitting/receiving unit 201, a binding information notifying message generating unit 202, a HoA1 binding information control unit 203, a HoA2 binding information control unit 204, a pre-transfer buffering request judging unit 205, a flow information notifying message generating unit 206, a home address association judging unit 207, and a flow information control unit 208. MN 10 has data packet processing unit and various other functions for processing of data packets transmitted and received to and from CN 40, but these are not shown in FIG. 8.

The transmitting/receiving unit 201 has the function to transmit and receive packets for the purpose of performing communication with an arbitrary communication node in the network, to which MN 10 is connected (e.g. the foreign network 30 shown in FIG. 1), an arbitrary communication node in the home networks 50 and 70 of MN 10 (e.g. HA 60 or HA 80 in FIG. 7), and an arbitrary communication node, which is present in other arbitrary network (e.g. CN 40 in FIG. 7). The transmitting/receiving unit 201 also has the function of the interface 20 for radio connection as shown in FIG. 7, for instance.

The binding information notifying message generating unit 202 has the function to generate a binding information notifying message including the binding information as notified from the HoA1 binding information control unit 203 or the HoA2 binding information control unit 204. At the binding information notifying message generating unit 202, the following messages are generated: a binding update message of the conventional Mobile IPv6 to register the binding information and a message to request the transfer after temporary buffering of the packet addressed to the care-of address as specified by the binding information together with the registration of the binding information. To the care-of address, which is to be an object to request the transfer after temporary buffering of the packet addressed to the care-of address, a pre-transfer buffering request is added. The binding information notifying message generated at the binding information notifying message generating unit 202 is transmitted to HA (HA 60 or HA 80) of MN 10 via the transmitting/receiving unit 201.

The HoA1 binding information control unit 203 has the function to control binding information relating to HoA1 (the home address assigned from the home network 50 shown in FIG. 7). It is also provided with the function to judge whether the binding information relating to the care-of addresses should be notified to HA 60 or not when the care-of addresses to be associated with HoA1 are acquired or changed. When it is judged that the binding information should be notified, the HoA1 binding information control unit 203 gives an instruction to the binding information notifying message generating unit 202 to generate a binding information notifying message by supplying the binding information to be notified.

When an instruction is given from the pre-transfer buffering request judging unit 205 to add pre-transfer buffering request to a specific care-of address or when an instruction is given from the home address association judging unit 207 to register the home address as the care-of address, the HoA1 binding information control unit 203 gives an instruction to the binding information notifying message generating unit 202 to generate a binding information notifying message where the pre-transfer buffering request is added.

The pre-transfer buffering request is a request to perform the buffering of a packet temporarily before the packet transfer is started to a specific care-of address selected as the transfer destination address. When the care-of address where the pre-transfer buffering request is added is selected, HA does not immediately start the transfer of the packet but performs the buffering of the packet for once and starts the transfer of the packet by intentionally delaying the timing to start the transfer of the packet to some extent (with an arbitrary time delay).

The HoA2 binding information control unit 204 has the function to control the binding information relating to HoA2 (a home address assigned from the home network 70 shown in FIG. 7). It also has the function to judge whether the binding information relating to these care-of addresses should be notified to HA 80 or not when the care-of addresses to be associated with HoA2 are acquired or changed. In case it is judged that the binding information should be notified, the HoA2 binding information control unit 204 gives an instruction to the binding information notifying message generating unit 202 to generate a binding information notifying message by supplying the binding information to be notified.

When an instruction is given from the pre-transfer buffering request judging unit 205 to add a pre-transfer buffering request to a specific care-of address, or when an instruction is given from the home address association judging unit 207 to register home address as care-of address, the HoA2 binding information control unit 204 gives an instruction to the binding information notifying message generating unit 202 to generate a binding information notifying message where the pre-transfer buffering request is added.

Regardless of whether the pre-transfer buffering request is added or not, lifetime included in the binding information notifying message to register home address as care-of address may contain a value, which indicates that there is no time limit for effective period. In this case, the binding information held by HA has no time limit on the effective period, and it is possible to continuously request HA to intercept the packet addressed to HoA at all times. As a result, even when all of the binding information relating to ordinary care-of address may be deleted, only this entry continues to remain, and the intercept by HA can be maintained in effective state.

Also, in order that the address to be the destination of the packet transfer after the execution of the pre-transfer buffering by HA may always be maintained in effective state at all times, it may be so arranged that the pre-transfer buffering request is added only to the home address, which is registered as care-of address. In this case, the packet to be transferred after the pre-transfer buffering has been performed by HA is again intercepted by another HA. This makes it possible to receive the effect of the pre-transfer buffering by HA.

The timing of the judgment by the HoA1 binding information control unit 203 and the HoA2 binding information control unit 204 to judge whether the binding information should be notified to HA or not is not limited—not only to the time when the instruction given from the pre-transfer buffering request judging unit 205 has been received, but also to the time when the moving to other network has been detected or the time when a new CoA has been generated and acquired, for instance. This timing also includes: the time when an interval to update the binding information notified from HA has come nearer, or the effective period of the binding information is almost expiring, or the time when a binding refresh request message from HA has been received.

Here, assumption is made on a case where two home addresses (i.e. HoA1 and HoA2) are assigned to MN 10, and FIG. 8 shows a state where MN 10 has the HoA1 binding information control unit 203 and the HoA2 binding information control unit 204, which control these two home addresses (HoA1 and HoA2) respectively, while adequate number of the corresponding HoA binding information control units may be present, depending on the number of the assigned home addresses. The HoA1 binding information control unit 203 and the HoA2 binding information control unit 204 have basically the same function and only the home addresses to control are different, and these may be unified to a single HoA binding information control unit, which can control a plurality of home addresses.

The pre-transfer buffering request judging unit 205 has the function to judge whether the pre-transfer buffering request should be added or not to the care-of address to be registered at each of HAs (HA 60 or HA 80), or to the care-of address already registered. When it is decided that the pre-transfer buffering request should be added to a specific care-of address, the pre-transfer buffering request judging unit 205 has the function to give an instruction to the corresponding HoA binding information control unit (i.e. the HoA1 binding information control unit 203 or the HoA2 binding information control unit 204) to add the pre-transfer buffering request to a specific care-of address.

For instance, when it is detected in advance that the connection of a certain interface 20 has become unstable for a certain period of time due to the influence of handover or the like, the pre-transfer buffering request judging unit 205 can decide that the pre-transfer buffering request is to be added to the care-of address, which is assigned to the interface 20.

When a care-of address where the pre-transfer buffering request is not added has been selected as a transfer destination, HA (HA 60 or HA 80) immediately starts to transfer the packet. As a result, the packet is continuously transferred from HA (HA 60 or HA 80) even during the period when connection is unstable, and packet loss may occur while MN 10 cannot receive the packet during this period. However, if the pre-transfer buffering request is added, HA does not start the packet transfer immediately and performs packet transfer after buffering has been performed when the care-of address is selected as transfer destination. This makes it possible to prevent the packet transfer during the period when connection is unstable.

When a notification is received from the flow information control unit 208, for instance, the pre-transfer buffering request judging unit 205 may judge that the pre-transfer buffering request should be added to a specific flow. When it is judged that the pre-transfer buffering request should be added to a specific flow, an instruction may be given to the flow information notifying message generating unit 206 to generate a flow information notifying message to notify the addition of the pre-transfer buffering request relating to a specific flow to HA (HA 60 or HA 80).

The pre-transfer buffering request judging unit 205 can give an instruction to the home address association judging unit 207 to use a specific home address as a care-of address of another home address and to add the pre-transfer buffering request. Upon receipt of this instruction, the home address association judging unit 207 gives an instruction to the HoA1 binding information control unit 203 or the HoA2 binding information control unit 204 as described later to register the home address where the pre-transfer buffering request has been added as the care-of address.

When it is decided that the pre-transfer buffering request should be added, the pre-transfer buffering request judging unit 205 may have the function to determine a buffering time and a buffering capacity when the buffering of the packet is performed temporarily before the packet transfer at HA (HA 60 or HA 80). The buffering time and the buffering capacity correspond to the delay of time to intentionally delay the packet transfer. The delay of time as defined at the pre-transfer buffering request judging unit 205 should be preferably notified to HA (HA 60 or HA 80) together with the pre-transfer buffering request.

When an instruction is given from the pre-transfer buffering request unit 205 to generate a message to notify the addition of the pre-transfer buffering request with respect to a specific flow to HA (HA 60 or HA 80) as described above, the flow information notifying message generating unit 206 has the function to generate a flow information notifying message including the flow information where the pre-transfer buffering request is added.

The home address association judging unit 207 has the function to judge whether the home addresses (HoA1 and HoA2) held by MN 10 should be used as the care-of addresses to be associated with other home addresses. In case HoA1 can be used as care-of address of HoA2, an instruction can be given to the HoA2 binding information control unit 204 to associate HoA1 as the care-of address. On the other hand, in case HoA2 can be used as the care-of address of HoA1, an instruction can be given on the HoA1 binding information control unit 203 to associate HoA2 as the care-of address.

When an instruction is given from the pre-transfer buffering request judging unit 205 to add the pre-transfer buffering request relating to a specific home address, the home address association judging unit 207 gives an instruction to the HoA1 binding information control unit 202 or to the HoA2 binding information control unit 204 to register the home address where the pre-transfer buffering request is added as the care-of address.

FIG. 8 shows an arrangement where MN 10 can transmit both the binding information notifying message and the flow information notifying message to HA (HA 60 or HA 80), while it may be so arranged that only of one of the notifying messages can be transmitted. Specifically, MN 10 may notify the care-of address of an object where the pre-transfer buffering request is added by the binding information notifying message, or it may notify the flow of an object where the pre-transfer buffering request is added by the flow information notifying message, or it may notify both the care-of address and the flow of the object where the pre-transfer buffering request is added by using both messages.

In the arrangement of MN 10 as shown in FIG. 8, the binding notifying message is used in case the object where the pre-transfer buffering request is a care-of address, and the flow information notifying message is used in case the object where the pre-transfer buffering request is added is a flow. For instance, it may be so arranged that the binding information notifying message is used as a message to notify the pre-transfer buffering request relating to the flow. In this case, the pre-transfer buffering request information relating to the flow can be added as an option of the binding information notifying message. A flow information notifying message may be used as a message to notify the pre-transfer buffering request relating to the care-of address.

As described in the above by referring to FIG. 8, MN 10 in the second embodiment of the invention can request its own HA 60 to delay the timing to start the transfer of the packet addressed to MN 10 by starting the transfer of the packet after buffering has been performed to its own HA 60. Also, MN 10 can select the care-of address, which will be an object of the pre-transfer buffering request. Also, when one of a plurality of home addresses is registered as the care-of address of another home address, it may be so arranged that the pre-transfer buffering request is performed to a packet to be transferred to a specific care-of address (one of a plurality of home addresses of MN 10) to HA (HA 60 or HA 80). Also, MN 10 may not only perform the pre-transfer buffering request to the packet addressed to a specific care-of address or to the packet relating to a specific flow but also may give the pre-transfer buffering request to the packet transmitted from a specific correspondent node.

FIG. 9 shows an example of a binding information notifying message generated and transmitted by MN 10 of the second embodiment of the invention. FIG. 9 gives an arrangement example of the binding information notifying message when a care-of address to associate HoA2 with HoA1 is notified by using a binding update message and the pre-transfer buffering is requested to this care-of address (HoA2).

An IPv6 header (to set HA 60 as a destination address), a home address option, and a mobility header (binding update) as shown in FIG. 9 are basically the same as the arrangement of the binding update message as defined in the Mobile IPv6. In the second embodiment of the present invention, as shown in FIG. 9, the pre-transfer buffering request information and the care-of address (HoA2) to be specified as the object of buffering are added to an alternate CoA option of the binding update message as defined in the Mobile IPv6. The pre-transfer buffering request information is the information to indicate the pre-transfer buffering request of the packet before the packet having HoA1 as a destination address is encapsulated by a packet having the care-of address (HoA2 in the example shown in FIG. 9) included in the alternate CoA option as destination address and the packet is transferred. For instance, this can be accomplished in an arbitrary form such as a flag.

When the pre-transfer buffering request is performed with respect to a specific flow, it is possible to use a flow information notifying message having the same format as shown in FIG. 4 (although the request included in the message is the pre-transfer buffering request). Also, a special-purpose pre-transfer buffering request message having the same format as shown in FIG. 5 may be used (although the message is a pre-transfer buffering request message).

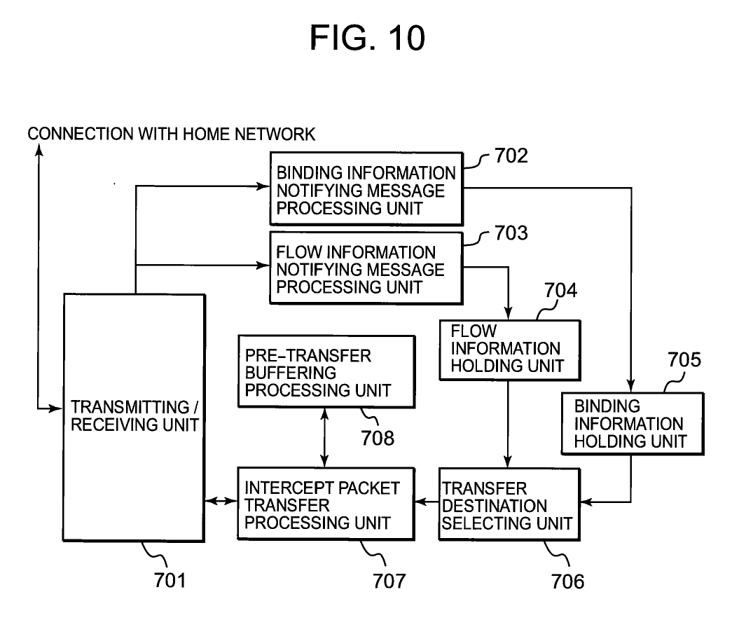

Next, description will be given on an arrangement of HA (HA 60 or HA 80) in the second embodiment of the invention. FIG. 10 shows an example of arrangement in the second embodiment of the invention. In FIG. 10, HA comprises a transmitting/receiving unit 701, a binding information notifying message processing unit 702, a flow information notifying message processing unit 703, a flow information holding unit 704, a binding information holding unit 705, a transfer destination selecting unit 706, an intercept packet transfer processing unit 707, and a pre-transfer buffering processing unit 708. HA has various other functions, but these are not shown in FIG. 10.

The transmitting/receiving unit 701 has the function to transmit and receive the packet for performing communication to and from an arbitrary communication node in a network, to which HA is connected (e.g. home networks 50 and 70 shown in FIG. 7), to and from MN 10 connected to the foreign network 30 (i.e. MN 10 belonging to home networks 50 and 70 where HA 60 or HA 80 is present), and, further, to and from an arbitrary communication node connected to the other arbitrary network.

The binding information notifying message processing unit 702 has the function to perform processing on the binding information notifying message, to acquire binding information of MN 10 included in the binding information notifying message, and to have the binding information to be held at the binding information holding unit 705. When the pre-transfer buffering request information is added with respect to the binding information, the pre-transfer buffering request information is held at the binding information holding unit 705 together with the binding information.

The flow information notifying message processing unit 703 has the function to perform processing on the flow information notifying message, to acquire flow information (flow identifier) of MN 10 included in the flow information notifying message, and to have this flow identifier to be held at the flow information holding unit 704 when a flow information notifying message generated and transmitted at MN 10 has been received at the transmitting/receiving unit 701. When the pre-transfer buffering request information is added with respect to a flow identifier, the pre-transfer buffering request information is held at the flow information holding unit 704 together with the flow identifier.

The flow information holding unit 704 has the function to hold a flow identifier extracted by the processing of the flow information notifying message at the flow information notifying message processing unit 703. When the pre-transfer buffering request information is added to the flow identifier, the pre-transfer buffering request information is also held together with the flow identifier.

The binding information holding unit 705 has the function to hold the binding information extracted by the processing of the binding information notifying message at the binding information notifying message processing unit 702 (i.e. binding information where home address of MN 10 is associated with a care-of address, which is to be an object of the pre-transfer buffering request of the packet). At the binding information holding unit 705, in addition to the binding information where the pre-transfer buffering request of a packet to be transferred to a specific care-of address is included, ordinary binding information where the buffering request is not included is also held.

When MN 10 receives the binding information notifying message to register home address as care-of address, there may be a case where the lifetime relating to the binding information extracted by the processing of the message is set to a value, which has no time limit for the effective period. In this case, the binding information to be held will not be deleted due to the expiration of the effective period. Thus, HA can continuously intercept the packet addressed to HoA of MN 10 at all times. It may be so arranged that the binding information holding unit 705 can hold the binding information as the information with no expiration of the effective period. In this case, however, MN 10 must add the pre-transfer buffering request only to the home address to be registered as the care-of address. When the binding information with a value to indicate that there is no expiration of the effective period is to be held, it may be so arranged that the pre-transfer buffering request information is added at all times. In the binding information with a value to indicate that there is no expiration of the effective period, it is preferable that the home address is registered as the care-of address.

The transfer destination selecting unit 706 has the function to select a care-of address to be used as a transfer destination address from the binding information holding unit 705. The transfer destination selecting unit 706 also has the function to select a care-of address to be used as a transfer destination of a specific flow by referring to a flow identifier of MN 10 held at the flow information holding unit 704 as the transfer destination of the packet addressed to HoA of MN 10 as intercepted, and also by referring to the binding information holding unit 705.

The intercept packet transfer processing unit 707 has the function to request the transfer destination selecting unit 706 to select the transfer destination of the packet when a packet addressed to HoA of MN 10 has been intercepted, to acquire the result of the selection, and when the pre-transfer buffering request is added to the selected care-of address, to deliver the intercepted packet to the pre-transfer buffering processing unit 708 without transferring it immediately to its care-of address, and to give an instruction for buffering. When the pre-transfer buffering request is not added, the intercept packet transfer processing unit 707 encapsulates the packet and immediately starts the transfer.

When it is notified from the pre-transfer buffering processing unit 708 that the buffer is full after the buffering of the packet is instructed to the pre-transfer buffering processing unit 708, the intercept packet transfer processing unit 707 starts to transfer the packet held by the pre-transfer buffering processing unit 708 to the care-of address of the transfer destination where the pre-transfer buffering request as selected by the transfer destination selecting unit 706 has been added. As a result, the packet buffered to the pre-transfer buffering processing unit 708 for once is to remain at the pre-transfer buffering processing unit 708 until the buffer will be completely filled. Thus, the transfer of the packet is performed with a delay for a certain period of time.

In this case also, it is so arranged that the transfer of the packet held at the pre-transfer buffering processing unit 708 is started when the buffer at the pre-transfer buffering processing unit 708 is completely filled, while the transfer of the packet may be started when a certain predetermined amount of packets are accumulated in the buffer, or the transfer of the packet may be started after the packets have been stored for a predetermined time period at the buffer. Further, when notification on delay time of the packets is received from MN 10, the transfer of the packet may be started after the packets have been stored at the pre-transfer buffering processing unit 708 as long as the notified delay time.

The pre-transfer buffering processing unit 708 has the function to perform buffering on the packets delivered from the intercept packet transfer processing unit 707. The packets delivered from the intercept packet transfer processing unit 707 are the packets with a specific care-of address as notified from MN 10 as a transfer destination or the packets relating to a specific flow. Therefore, at the pre-transfer packet buffering unit 708, buffering is performed only on the packets for buffering, for which buffering request has been received from MN 10. By performing the buffering on the packets at the pre-transfer buffering processing unit 708, it is possible to intentionally delay the timing of the packet transfer.

As described above by referring to FIG. 10, HA in the second embodiment of the invention can transfer the packet, for which buffering is requested from MN 10 (i.e. the packet to be transferred to a specific care-of address or the packet relating to a specific flow) with a certain delay time. When another home address of MN 10 is set at the specific care-of address, the packet, for which buffering is requested from MN 10, is to be transferred to another HA after it has been held at HA for a certain delay time.

Next, description will be given on an example of actual operation in the second embodiment of the invention by referring to a network arrangement as shown in FIG. 7. In the following, assumption is made on a case where the connection between MN 10 and the foreign network 30 is lost from some reason. The causes of disconnection may include mobile behavior of MN 10, for instance.

### [Operation Example of the Second Embodiment of the Invention]

When it is connected to the foreign network 30, MN 10 registers the binding information of home address (HoA1) and care-of address (CoA1) at HA 60 as the Mobile IPv6 processing. In this case, if MN 10 decides to request the buffering (pre-transfer buffering) to HA 60 for the preparation of the condition such as packet loss, in order to cope with the situations such as intermittent disconnection from the foreign network 30 caused by instability of radio connection or packet loss on packet transfer route, HoA2 is registered as the care-of address of HoA1, and a binding information notifying message added with the pre-transfer buffering request to request that buffering of the packets should be performed before the transfer of the packet to its care-of address (HoA2) is transmitted to HA 60. Specifically, two care-of addresses (CoA1 and HoA2) are set with respect to HoA1, and the pre-transfer buffering request information is to be added to HoA2, which is under the control of the other home agent (HA 80).

Similarly, MN 10 registers binding information of the home address (HoA2) and the care-of address (CoA1) at HA 80. Further, when it is decided that the buffering (pre-transfer buffering) is to be requested to HA 8, MN 10 registers HoA1 as the care-of address of HoA2 and a binding information notifying message where the pre-transfer buffering request to request the buffering of the packet is transmitted before the transfer of the packet to its care-of address (HoA1) to HA 80. Specifically, two care-of addresses (CoA1 and HoA1) are set with respect to HoA2 in this case, and pre-transfer buffering request information is added to HoA1 under the control of the other home agent (HA 60).

Upon receipt of these binding information notifying messages, HA 60 and HA 80 store the information included in the binding information notifying message at the binding information holding unit 705.

When the packet addressed to HoA1 of MN 10 has been intercepted. HA 60 transfers the packet to CoA1. Here, it is supposed that the connection between MN 10 and the foreign network 30 is lost, and that the failure of HA 60 to transfer the packet to CoA1 of MN 10 has been detected by the receiving of a destination unreachable message. In this case, to cope with the failure of the packet transfer to CoA1, HA 60 selects another care-of address as a transfer destination. When HA 60 selects HoA2 as the next transfer destination instead of CoA1, HA 60 does not immediately transfer the packet to HoA2 because the pre-transfer buffering request is added to HoA2, and buffering is performed for once at the pre-transfer buffering processing unit 708. After storing the packet for a certain period of time (e.g. until the buffer where the packets are buffered will be completely filled), the packets are encapsulated and the transfer to HoA2 is started.

On the other hand, HA 80 intercepts the packet addressed to HoA2 as transferred from HA 60. The packet intercepted is further transferred by HA 80. If CoA1 is still cannot be used as transfer destination, HoA1 is selected as the transfer destination. Because the pre-transfer buffering request is added to HoA1, HA 80 does not transfer it immediately to HoA1 and buffering is performed to the pre-transfer buffering processing unit 708 for once. After the packets have been stored for a certain period of time (e.g. until the buffer where the packets are buffered will be completely filled). Then, the packets are encapsulated, and the transfer to HoA1 is started. As the result of this operation, the packets are continuously transferred among a plurality of HAs while buffering is performed repeatedly at each of HA 60 and HA 80.

For instance, in case the disconnection between MN 10 and the foreign network 30 is only temporary and MN 10 can be re-connected to the foreign network 30, the packet is transferred to CoA1 from HA 60 or HA 80. As a result, the packet loss can be prevented.

When MN 10 is re-connected and a new CoA is registered at each of HA 60 and HA 80, and when the packet is transferred to CoA, no packet loss occurs and MN 10 can receive the packet promptly. When the number of transfers of the packets between a plurality of HAs is limited to a certain number by using other arbitrary method, it is preferable to control so that the packets may not be continuously transferred between the plurality of HAs for long time (or permanently).

In the operation example as given above, the buffering of the packets addressed to a specific care-of address is performed on a network by continuous transfer between a plurality of HAs, while it may be so designed that the pre-transfer buffering is effective only for the packets relating to a specific flow. Specifically, by giving consideration on the flow information, it may be so arranged that only the packets relating to a specific flow directed to a specific care-of address are continuously transferred between a plurality of HAs, and that the buffering of the packets is performed on the network.

In the above, description has been given on the arrangement and the operation where MN 10 has two home addresses, while the present invention can be applied to the case where there are three or more home addresses. In such case, home address is registered as care-of address added with the pre-transfer buffering request so that pre-transfer buffering can be performed sequentially and continuously by a plurality of HAs in use, and this makes it possible to increase the amount of buffering as many as the number of HAs in use, and to reduce the packet loss.

As described above, according to the second embodiment of the invention, by adding pre-transfer buffering request information to the care-of address to be registered in HA, HA can transfer the packets after performing the buffering of the transfer packets addressed to its care-of address for once. In particular, when MN has a plurality of home addresses and the other home address is associated by using the care-of address of a certain home address, the packets, for which buffering cannot be performed by a single HA, can be transferred to another HA. Thus, the transfer of the packets is carried out between a plurality of HAs. As a result, it is possible to accomplish the buffering between a plurality of HAs. Further, when the same care-of address is turned to reachable again or in case another care-of address is registered (i.e. it is turned to a state where it can reach the interface of MN 10), by transmitting the packets, for which buffering has been performed between a plurality of HAs, it is possible to minimize the packet loss and to accomplish efficient retransmission control.

As shown in FIG. 13, when MN 10 is connected to a local network 515 where mobility protocol of network base is provided, the proxy mobile agent 518, which controls the moving of MN 10 on proxy may have the function as maintained by MN 10 in the second embodiment of the invention. In this case, the proxy mobile agent 518 may judge the object of the packet to be buffered selectively at its own judgment, or an instruction may be given from MN 10. By monitoring the connecting state of MN 10 at adequate timing, the proxy mobile agent 518 may select that pre-transfer buffering request information is not notified when the connection of MN 10 is stable, and the notification of the pre-transfer buffering request information may be selected when the connection of MN 10 is lost or when the connection is unstable. The proxy mobile agent 518 notifies the pre-transfer buffering request information thus decided to HA 60, which has MN 10 under the control.

The proxy mobile agent 518 may have the function, with which HA in the second embodiment of the invention is provided. In this case, MN 10 adds the pre-transfer buffering request information to the flow information and notifies it to the proxy mobile agent 518. When this notification is received and when the packet addressed to the home address (HoA1) of MN 10 transferred from HA 60 concurs with the flow where the pre-transfer buffering request information is added, the proxy mobile agent 518 does not transfer the packet immediately to MN 10, but buffering is performed to the pre-transfer buffering processing unit 708 for once. After storing the packet for a certain period of time (e.g. until the buffer where the packets are buffered will be completely filled), the packets are encapsulated and the transfer to MN 10 is started. Also, the proxy mobile agent may judge the object of the packets to be buffered at its own judgment. By monitoring the connection state of MN 10 at adequate timing, when the connection of MN 10 is stable, the proxy mobile agent 518 selects that the pre-transfer buffering will not be carried out and may select to perform the pre-transfer buffering when the connection of MN 10 is lost or when the connection is unstable.

### 3rd Embodiment

Next, description will be given on a third embodiment of the invention. The third embodiment of the invention is basically a combination of the first embodiment and the second embodiment of the invention. In the third embodiment, actual example of the network arrangement will be described with the network arrangement shown in FIG. 7 as the precondition.

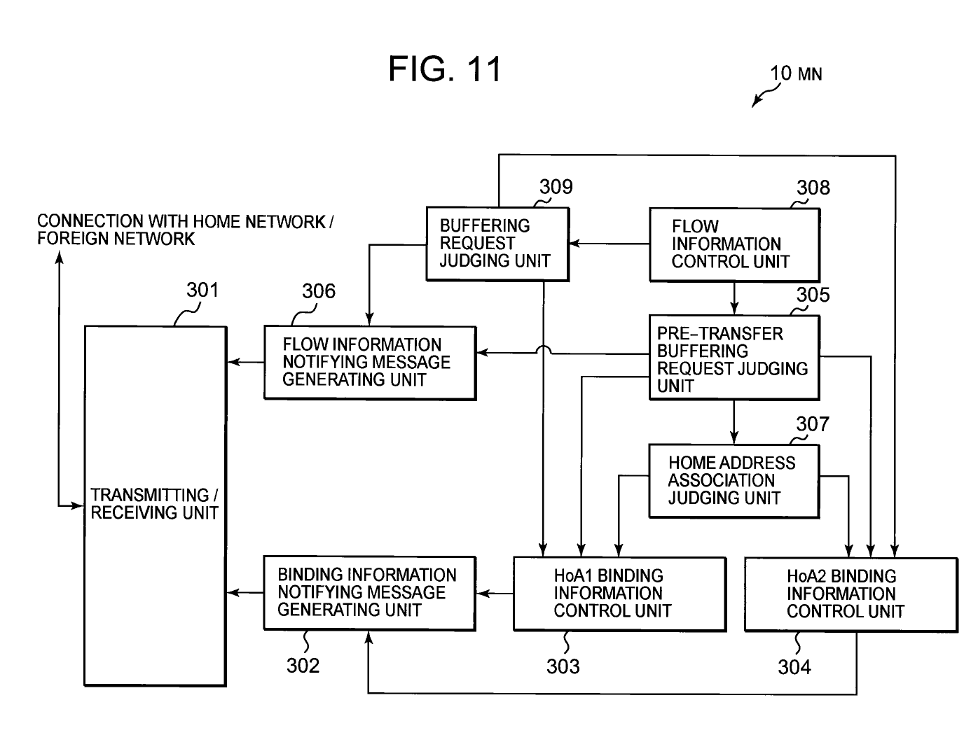

First, description will be given on the arrangement of MN 10 in the third embodiment of the invention. FIG. 11 shows an example of arrangement of MN 10 in the third embodiment of the invention. In FIG. 11, MN 10 comprises a transmitting/receiving unit 301, a binding information notifying message generating unit 302, an HoA1 binding information control unit 303, an HoA2 binding information control unit 304, a pre-transfer buffering request judging unit 305, a flow information notifying message generating unit 306, a home address association judging unit 307, a flow information control unit 308, and a buffering request judging unit 309. MN 10 shown in FIG. 11 is basically a combination of MN 10 shown in FIG. 2 and MN 10 shown in FIG. 8.

In FIG. 11, the transmitting/receiving unit 301 shown in FIG. 11 is the same as the transmitting/receiving unit 101 shown in FIG. 2 or the transmitting/receiving unit 201 shown in FIG. 8.

The binding information notifying message generating unit 302 has the functions of the binding information notifying message generating unit 102 shown in FIG. 2 and the functions of the binding information notifying message generating unit 202 shown in FIG. 8. The details of the functions are not given here. The binding information notifying message generating unit 302 can generate a binding information notifying message, which contains the buffering transfer request information and/or the pre-transfer buffering transfer request information.

The HoA1 binding information control unit 303 has the functions of both of the binding information control unit 103 shown in FIG. 2 and the HoA1 binding information control unit 203 shown in FIG. 8. The details of the functions are not given here. The HoA1 binding information control unit 303 has the function to give an instruction to the binding information notifying message generating unit 302 to generate a binding information notifying message where the pre-transfer buffering request is added according to an instruction from the pre-transfer buffering request judging unit 305, and it has also the function to give an instruction to the binding information notifying message generating unit 302 to generate a binding information notifying message where the buffering request is added.

The HoA2 binding information control unit 304 has the functions of both of the binding information control unit 103 shown in FIG. 2 and the HoA2 binding information control unit 204 shown in FIG. 8. The details of the functions are not given here. The HoA1 binding information control unit 303 executes the control on HoA1, and the HoA2 binding information control unit 304 carries out the control on HoA2.

The pre-transfer buffering request judging unit 305 is the same as the pre-transfer buffering request judging unit 205 shown in FIG. 8.

The flow information notifying message generating unit 306 has the functions of both of the flow information notifying message generating unit 105 shown in FIG. 2 and the flow information notifying message generating unit 206 shown in FIG. 8. The details of the functions are not given here. The flow information notifying message generating unit 306 can generate a flow information notifying message, which contains the buffering transfer request information and/or the pre-transfer buffering transfer request information.

The home address association judging unit 307 is the same as the home address association judging unit 207 shown in FIG. 8.

The flow information control unit 308 has the functions of both of the flow information control unit 106 shown in FIG. 2 and the flow information control unit 208 shown in FIG. 8. The details of the functions are not given here.

The buffering request judging unit 309 is the same as the buffering request judging unit 104 shown in FIG. 2.

In FIG. 11, MN 10 has such an arrangement that it can transmit both the binding information notifying message and the flow information notifying message to HA (HA 60 or HA 80), while it may be so arranged that it can transmit only one of the notifying messages. That is, MN 10 may notify only the care-of address of the object where the buffering request and/or the pre-transfer buffering request are added by the binding information notifying message, or it may notify only the flow of an object where the buffering request and/or the pre-transfer buffering request are added by the flow information notifying message, or it may notify both of the care-of address and the flow of an object where the buffering request and/or the pre-transfer buffering request are added.

In the arrangement of MN 10 shown in FIG. 11, the binding notifying message is used if the object where the buffering request and/or the pre-transfer buffering request is added is a care-of address. When the object where the buffering request and/or the pre-transfer buffering request is added is a flow, a flow information notifying message is used. As a message to notify the buffering request and/or the pre-transfer buffering request to the flow, a binding information notifying message may be used. In this case, the buffering request and/or the pre-transfer buffering request information to the flow can be added as an option for the binding information notifying message, for instance. Also, as the message to notify the buffering request and/or the pre-transfer buffering request to the care-of address, a flow information notifying message may be used.

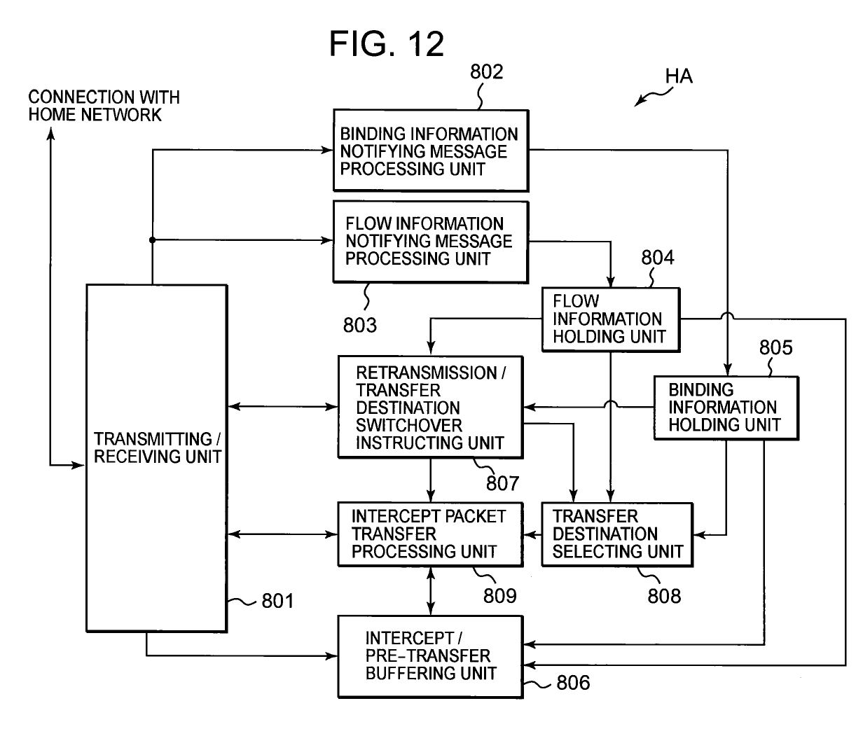

Next, description will be given on an arrangement of HA (HA 60 or HA 80). FIG. 12 shows an example of arrangement of HA in the third embodiment of the invention. In FIG. 12, HA comprises a transmitting/receiving unit 801, a binding information notifying message processing unit 802, a flow information notifying message processing unit 803, a flow information holding unit 804, a binding information holding unit 805, an intercept/pre-transfer buffering unit 806, a retransmission/transfer destination switchover instructing unit 807, a transfer destination selecting unit 808, and an intercept packet transfer processing unit 809. HA as shown in FIG. 12 has an arrangement where HA shown in FIG. 6 is combined with HA shown in FIG. 10.

The transmitting/receiving unit 801 shown in FIG. 12 is the same as the transmitting/receiving unit 601 shown in FIG. 6 or the transmitting/receiving unit 701 shown in FIG. 10.

The binding information notifying message processing unit 802 has the functions of both of the binding information notifying message processing unit 602 shown in FIG. 6 and the binding information notifying message processing unit 702 shown in FIG. 10. The details of the functions are not given here. At the binding information notifying message processing unit 802, processing is performed on the binding information notifying message where the buffering request information and/or the pre-transfer buffering request information is added.

The flow information notifying message processing unit 803 has the functions of both of the flow information notifying message processing unit 603 shown in FIG. 6 and the flow information notifying message processing unit 703 shown in FIG. 10. The details of the functions are not given here. At the flow information notifying message processing unit 803, processing is performed on a flow information notifying message where the buffering request information and/or the pre-transfer buffering request information are added.

The flow information holding unit 804 has the functions of both of the flow information holding unit 604 shown in FIG. 6 and the flow information holding unit 704 shown in FIG. 10. The details of the functions are not given here. At the flow information holding unit 804, flow information is held where the buffering request information and/or the pre-transfer buffering request information are added.

The binding information holding unit 805 has the functions of both of the binding information holding unit 605 shown in FIG. 6 and the binding information holding unit 705 shown in FIG. 10. The details of the functions are not given here. The binding information holding unit 805 holds binding information where the buffering request information and/or the pre-transfer buffering request information are added.

The intercept pre-transfer buffering unit 806 has the functions of both of the intercept packet buffering unit 606 shown in FIG. 6 and the pre-transfer buffering processing unit 708 shown in FIG. 10. The details of the functions are not given here. At the intercept pre-transfer buffering unit 806 there are: a packet to be buffered at the same time as the transfer for the purpose of retransmission (i.e. a packet to be an object of buffering request), and a packet to be buffered before the transfer for the purpose of transfer (i.e. packet to be an object of the pre-transfer buffering request).

The retransmission/transfer destination switchover instructing unit 807 is the same as the retransmission/transfer destination switchover instructing unit 607 shown in FIG. 6.

The transfer destination selecting unit 808 has the functions of both of the transfer destination selecting unit 608 shown in FIG. 6 and the transfer destination selecting unit 706 shown in FIG. 10. The details of the functions are not given here.

The intercept packet transfer processing unit 809 has the functions of the intercept transfer processing unit 609 shown in FIG. 6 and the intercept packet transfer processing unit 707 shown in FIG. 10. The details of the functions are not given here. The intercept packet transfer processing unit 809 retransmits or transfers a packet by acquiring it from the intercept pre-transfer buffering unit 806 when a packet designated by the buffering request is to be retransmitted or when a packet designated by the pre-transfer buffering request is to be transferred.

In the third embodiment of the invention, by combining the buffering request information with the pre-transfer buffering request information, it is possible to set up the rules to define various aspects of the buffering. For instance, in case of the packet addressed to a care-of address where the buffering request information is added or a packet relating to a flow, it can be so arranged that the pre-transfer buffering can be automatically performed regardless of whether the pre-transfer buffering request information is present or not, or it can also be so arranged that the pre-transfer buffering can be performed only on a packet addressed to a care-of address where the buffering request information is added or a packet relating to a flow.

Next, description will be given on an example of actual operation in the third embodiment of the invention by referring to the network arrangement shown in FIG. 7. In the following, assumption is made on a case where MN 10 is disconnected to the foreign network 30 due to some reason. The causes of disconnection may include mobile behavior of MN 10, for instance.

### [A First Operation Example of the Third Embodiment of the Invention]

First, description will be given on a first operation example in the third embodiment of the invention. When MN 10 is connected to the foreign network 30, binding information of home address (HoA1) and care-of address (CoA1) is registered at HA 60 as ordinary processing of the Mobile IPv6.

In this case, if MN 10 decides that a packet addressed to the care-of address to be registered should be buffered to HA 60 in the preparation for intermittent disconnection with the foreign network 30 caused by instability of radio connection or packet loss on the packet transfer route, a binding information notifying message where the buffering request is added with respect to the care-of address (CoA1) is transmitted to HA 60.

Further, in this case, if MN 10 decides that the buffering (pre-transfer buffering) should be requested to HA 60 in the preparation for intermittent disconnection with the foreign network 30 caused by instability of radio connection or by packet loss on packet transfer route, HoA2 is registered as the care-of address of HoA1, and a binding information notifying message where the pre-transfer buffering request is added to request the buffering of the packet before the transfer of the packet to the care-of address is transmitted to HA 60.

Specifically, it is supposed here that two care-of addresses (CoA1 and HoA2) are set with respect to HoA1, and that CoA1 is added with the buffering request information and the pre-transfer buffering request information is added to HoA2, which is under the control of the other home agent (HA 80).

On the other hand, binding information of the home address (HoA2) and the care-of address (CoA1) is registered at HA 80, for instance. Further, when it is decided that the buffering (pre-transfer buffering) should be requested to HA 80, MN 10 registers HoA1 as the care-of address of HoA2, and a binding information notifying message added with the pre-transfer buffering request to request the buffering of packet before the packet transfer to the care-of address (HoA1) is transmitted to HA 80.

When HA 60 and HA 80 receive these binding information notifying messages respectively, the information contained in each of the binding information notifying messages is stored in the binding information holding unit 805.

When a packet addressed to HoA1 of MN 10 is intercepted, HA 60 transfers the packet to CoA1, and, at the same time, performs the buffering of the packet to be transferred to CoA1. The buffering of the packet is used when the retransmission of the packet has been decided.

It is supposed here that the connection of MN 10 with the foreign network 30 has been lost and the failure of HA 60 to transfer the packet to CoA1 of MN 10 has been detected by the receiving of a destination unreachable message, for instance. In this case, to cope with the failure of the packet transfer to CoA1, HA 60 selects another care-of address as transfer destination. The timing of the switchover of transfer destination can be decided according to an arbitrary method such as the switchover of transfer destination of the packet when the packet does not reach MN 10 even when attempts have been made as many times as required.

When HA 60 selects HoA2 as the next transfer destination instead of CoA1, HA 60 does not immediately transfer the packet to HoA2 because HoA2 is added with the pre-transfer buffering request, and buffering is performed to the pre-transfer buffering processing unit 708 for once. After storing the packet for a certain period of time (e.g. until the buffer where the packets are buffered will be completely filled), the packets are encapsulated, and the transfer to HoA2 is started.

On the other hand, HA 80 intercepts the packet addressed to HoA2 as transferred from HA 60. The intercepted packet is transferred by HA 80. If CoA1 cannot be used as transfer destination, HoA1 is selected as the transfer destination. In this case, HA 80 does not immediately transfer the packet to HoA1 because HoA1 is added with the pre-transfer buffering request, and buffering is performed to the pre-transfer buffering processing unit 708 for once. After storing the packet for a certain period of time (e.g. until the buffer where the packets are buffered will be completely filled), the packets are encapsulated, and the transfer to HoA1 is started. As the result of this operation, the packets are continuously transferred between a plurality of HAs by repeating the buffering at HA 60 and HA 80.

### [A Second Operation Example of the Third Embodiment of the Invention]

Next, description will be given on a second operation example in the third embodiment of the invention. When MN 10 is connected with the foreign network 30, MN 10 registers binding information of home address (HoA1) and care-of address (CoA1) at HA 60 as ordinary processing of the Mobile IPv6. For instance, when MN 10 decides that the buffering of the packet relating to a specific flow (a flow 1) in communication should be requested to HA 60 in the preparation for intermittent disconnection with the foreign network 30 caused by instability of radio connection or for packet loss on the packet transfer route, MN 10 transmits a binding information notifying message added with the buffering request relating to the flow 1 to HA 60.

Further, MN 10 registers HoA2 as the care-of address of HoA1 and transmits a binding information notifying message added with the pre-transfer buffering request, which requests that the buffering of the packet should be performed before the packet transfer to the care-of address (HoA2) to HA 60.

Specifically, it is supposed here that two care-of addresses (CoA1 and HoA2) are set to HoA1 and buffering request information is added with respect to a specific flow 1, and that the pre-transfer buffering request information is added to HoA2, which is under the control of the other home agent (HA 80).

When HA 60 and HA 80 receive these binding information notifying messages respectively, the types of information contained in the binding information notifying messages are stored at the binding information holding unit 805.

When the packet addressed to HoA1 of MN 10 is intercepted, HA 60 transfers the packet to CoA1, and, at the same time, performs the buffering of the packet with respect to the flow 1. The buffering of the packet in this case is used when the retransmission of the packet has been decided.

It is supposed here that the connection of MN 10 with the foreign network 30 is lost and the failure of HA 60 to transfer the packet to CoA1 of MN 10 has been detected by the receiving of a destination unreachable message, for instance. In this case, to cope with the failure of the packet transfer to CoA1, HA 60 selects another care-of address as a transfer destination. When HA 60 selects HoA2 as the next transfer destination instead of CoA1, HA 60 does not immediately transfer the packet addressed to CoA1 to HoA2 because the pre-transfer buffering request is added to HoA2, and buffering is performed to the intercept pre-transfer buffering processing unit 806 for once. Then, after storing the packet for a certain period of time (e.g. until the buffer where the packets are buffered will be completely filled), the packets are encapsulated, and the transfer to HoA2 is started. It may be so arranged that HA 60 performs the pre-transfer buffering processing only to the packet with respect to the flow 1 where the buffering request is added and the pre-transfer buffering is not performed for the packets not relating to the flow 1.

On the other hand, HA 80 intercepts a packet addressed to HoA2 as transferred from HA 60. The packet intercepted is transferred by HA 80. When CoA1 is still cannot be used as transfer destination, HoA1 is selected as transfer destination. In this case, HA 80 does not immediately transfer the packet to HoA1 because HoA1 is added with the pre-transfer buffering request, and buffering is performed to the pre-transfer buffering processing unit 708 for once. Then, after storing the packets for a certain period of time (e.g. until the buffer where the packets are buffered will be completely filled), the packets are encapsulated, and the transfer to HoA1 is started. As the result of this operation, the packets are continuously transferred between a plurality of HAs by repeating the buffering at HA 60 and HA 80. Three or more HAs may be used. In such case, the home addresses added with the pre-transfer buffering request are registered as care-of addresses so that the pre-transfer buffering can be continuously and sequentially performed by a plurality of HAs. As a result, the amount of the packets to be buffered can be increased to match the number of HAs available. This makes it possible to reduce the packet loss.

As described in the above, according to the third embodiment of the invention, the first embodiment and the second embodiment of the invention as described above can be used in combination. Also, even when a specific care-of address is designated in the transfer buffering request, it can be so arranged that the pre-transfer buffering processing can be performed only to the packet, which is the object of the buffering request (e.g. a packet relating to a specific flow). Thus, to match the combination of the buffering request information with the pre-transfer buffering request information, the rules to define various aspects of buffering can be set up as necessary.

When MN 10 is connected to a local network 515 where mobility protocol of network base is provided, the proxy mobile agent 518 for the control on proxy for the mobile behavior of MN 10 may have the function, with which MN 10 in the third embodiment of the invention is provided. In this case, the proxy mobile agent 518 may judge the object of the packet, for which selective buffering and pre-transfer buffering should be performed at its own judgment or an instruction may be given from MN 10. When the connection of MN 10 is stable, MN 10 may select that the selective buffering and the pre-transfer buffering request information are not notified by monitoring the connection state of MN 10 at adequate timing, and may select that selective buffering and the pre-transfer buffering request information are selected when the connection of MN 10 is lost or the connection is unstable. The proxy mobile agent 518 notifies the buffering request and the pre-transfer buffering request information thus decided to HA 60, which has MN 10 under the control.

The proxy mobile agent 518 may have the function, which HA in the third embodiment of the invention has. In this case, MN 10 adds the buffering request information and the pre-transfer buffering request information to the flow information and notifies it to the proxy mobile agent. Upon receipt of this notification, the proxy mobile agent 518 performs the buffering when the packet addressed to the home address (HoA1) of MN 10 as transferred from HA 60 concurs with the flow where the buffering request information is added. Further, when it is decided that retransmission is required due to the instability of connection of MN 10 or other cause, retransmission is performed by using the packet under buffering. When the packets concur with the flow where the pre-transfer buffering request information is added, the packet is not immediately transmitted to MN 10, but it is buffered at the pre-transfer buffering processing unit 708 for once. Then, after storing the packets for a certain period of time (e.g. until the buffer where the packets are buffered will be completely filled), the packets are encapsulated, and the transfer to MN 10 is started. The proxy mobile agent 518 may judge the object of the packet to be processed by selective buffering and the pre-transfer buffering at its own judgment. The proxy mobile agent 518 monitors the connection state of MN 10 at adequate timing, and if the connection of MN 10 is stable, it may be so arranged that the proxy mobile agent 518 selects that selective buffering and the pre-transfer buffering should not be performed, and that the selective buffering and the pre-transfer buffering are selected when the connection of MN 10 is lost or the connection in not stable.

In the present specification, description is given separately on the techniques in the first to the third embodiments of the invention, while the purpose of the invention can be accomplished by adequately combining the techniques relating to the first to the third embodiments.

Each of the functional blocks explained in the description of each embodiments of the invention as described above can be realized as LSI (large scale integration), which is typically represented by integrated circuit. These can be realized individually as one chip or may be designed in a single chip including a part or all. Here, it is referred as LSI, while it can also be called IC (integrated circuit), system LSI, super LSI or ultra LSI, depending on the degree of integration.

The technique of designing the integrated circuit is not limited to that of LSI, but it may be accomplished as a dedicated circuit or a general-purpose processor. Or, after producing LSI, it can be designed as a FPGA (field programmable gate array), which can be programmed after the production of LSI, or a reconfigurable processor, in which connection and setting of circuit cell inside LSI can be reconfigured, may be used.

Further, when new technique of the integration of circuit to substitute LSI will be developed or another type of technique may be derived in the progress of semiconductor technique, the functional blocks may be integrated by using such technique. For instance, the adoption to biotechnology is one of such possibilities.

### INDUSTRIAL APPLICABILITY

The present invention provides the effects that retransmission control relating to packets effective for MN can be executed on the packet to be transmitted from CN to MN via HA. This can be applied to packet transfer technique and address control technique. In particular, it can be applied to packet transfer technique and address control technique in the Mobile IPv6.

1. A packet transfer control device for controlling packet transfer of a home agent belonging to a certain predetermined network, wherein said device comprises:
binding information controlling means for performing address control of a mobile node to which a home address is assigned from said predetermined network;
packet transferring means for intercepting a first packet addressed to said home address, for generating a second packet by encapsulating said first packet by using a header addressed to said care-of address, and for generating and transferring the second packet;
buffering request receiving means for receiving, from said mobile node, a request of buffering of transfer packet satisfying a predetermined condition in the transfer of the packet performed by said packet transfer means; and
buffering means for performing buffering of said transfer packet satisfying said predetermined condition when a request of buffering of said transfer packet satisfying said predetermined condition is received by said buffering request receiving means.

2. The packet transfer control device according to claim 1, wherein said predetermined condition is at least one of the following conditions: a condition that destination of the transfer packet is a predetermined care-of address, or a condition that the transfer packet has predetermined flow information, or a condition that said transfer packet is a packet transmitted from a predetermined correspondent node.

3. The packet transfer control device according to claim 1, wherein said buffering request receiving means is so arranged to receive a request to perform buffering on said transfer packet at the same time as the transfer of said transfer packet from said mobile node.

4. The packet transfer control device according to claim 1, wherein said buffering request receiving means is so arranged to receive a request to temporarily perform buffering from said mobile node before said transfer packet is transferred.

5. The packet transfer control device according to claim 1, wherein said care-of address is a home address assigned to said mobile node from said predetermined network.

6. A mobile node having, in addition to a first address as assigned from a first network, a second address assigned from a second network different from said first network, wherein said mobile node comprises:
address associating means for setting said first address as a home address and for associating said second address as a care-of address of said first address;
binding information registration means for registering binding information of said first address and said second address associated by said address associating means at a home agent of said first network; and
buffering requesting means for intercepting the first packet addressed to said first address and for requesting buffering of transfer packet satisfying a predetermined condition to said home agent of said first network to transfer the second packet generated by encapsulating said first packet by using a header addressed to said second address.

7. The mobile node according to claim 6, wherein said predetermined condition is at least one of the following conditions: a condition that destination of the transfer packet is a predetermined care-of address, or a condition that the transfer packet has predetermined flow information, or a condition that said transfer packet is a packet transmitted from a predetermined correspondent node.

8. The mobile node according to claim 6, wherein said buffering requesting means is so arranged to request buffering of said transfer packet to said home agent at the same time as the transfer of said transfer packet.

9. The mobile node according to claim 6, wherein said buffering requesting means is so arranged to request for temporary buffering before the transfer of said transfer packet to said home agent.

10. The mobile node according to claim 6, wherein said second address is a home address as assigned from said second network.
